(19) United States
(12) Patent Application Publication
(10) Pub. No.: US 2019/0304032 A1
(43) Pub. Date: Oct. 3, 2019

(54) METHOD OF TAX DEDUCTION CREDIT FOR PURCHASE

(71) Applicant: Yury Shapshal, Brooklyn, NY (US)

(72) Inventor: Yury Shapshal, Brooklyn, NY (US)

(21) Appl. No.: 15/937,436

(22) Filed: Mar. 27, 2018

(51) Int. Cl. G06Q 40/00; G06Q 30/02; G06Q 20/34; G06Q 20/06

(52) U.S. Cl. CPC G06Q 40/123; G06Q 30/0279; G06Q 2220/00; G06Q 20/065; G06Q 20/34

(57) ABSTRACT

A method of generating charitable tax receipts from purchases with the tax receipt being generated in the name of the donor for deduction purposes. The sum donated may be a percentage of the purchase price or a set amount per item bought. The group or organization donated to may be chosen from a list. The tax receipt is generated by the “master” organization and mailed to an address, that is either electronic or non-electronic, that is determined by the donor with the “master” organization providing donor charitable contribution database and computer application for donors to access their respective donor contributions.

### BACKGROUND OF THE INVENTION

### Technical Field of the Invention

The present invention relates, generally, to a method for designating a portion of a financial transaction as intended to be donated to a charity and, more specifically, to make a charitable contribution in the donors name to a charity and issue a charitable contribution tax receipt to the donor and provide a method for tracking such contributions.

### Description of the Prior Art

Tax credits for charitable contributions have been part of the system for some time. The present invention seeks to improve this system by providing a way for a seller of a good or service to offer a portion of the product cost or a fixed value per purchase to be donated to a charity of the donor's choice and then to generate a charitable donation receipt to the donor. This is a substantial improvement on the current multi-step process in place where errors can be made and the purchaser may not get the credit for the donation, or has any way to track donations over time.

### SUMMARY OF THE INVENTION

A primary object of the present invention is to provide goods/services incorporating a charitable contribution portion as an integral part of the cost of goods/services merchandise.

Another object of the present invention is to provide a charitable contribution portion generating a charitable contribution tax receipt to a donor as an integral part of the financial purchasing transaction for the goods/services.

Yet another object of the present invention is to provide a charitable contribution tax receipt to a donor where the donor is either the buyer of the goods/services or the seller of the good/services.

Still yet another object of the present invention is to provide a method of monitoring tax deduction credits related to specific purchases.

An additional object of the present invention is to provide a method of tracking and generating tax deduction credits for a wide variety of goods and/or services.

A further object of the present invention is to provide a method of tracking and generating tax deduction credits where the donor may choose the recipient of the charitable contribution offered by the seller.

A yet further object of the present invention is to provide a method of tracking and generating tax deduction credit information where the seller of the good or service may generate a receipt for tax purchases that is sent to the donor.

A still yet further object of the present invention is to provide a method of tracking and generating tax deduction credit information where the seller of the good or service through a “master” qualified organization may generate a receipt for tax purchases.

Another object of the present invention is the “master” qualified organization maintaining a donor account database of donors' charitable contributions.

Yet another object of the present invention is the “master” qualified organization providing computer app for donor account access to their respective charitable contributions.

Additional objects of the present invention will appear as the description proceeds.

The foregoing and related objects are achieved by the present invention, in which a method for attributing and generating charitable tax receipts includes the steps of offering a good or service for sale combined with a monetary donation to a charitable organization, determining a monetary amount of the monetary charitable donation, determining a donor's personal information when the donor agrees to purchase the offered good or service, generating a charitable donation tax receipt from the donor's personal information, providing a master qualified organization for tracking donations and sending the charitable donation tax receipt to at least one predetermined address or printer.

The method of the present invention is to be practiced through a series of computerized terminals collectively forming a financial computerized network with individual terminals accessible to the person rendering the charitable contribution, the charity itself and/or the provider of a good or service.

Other objects and features of the present invention will become apparent when considered in combination with the accompanying drawing figures, which illustrate certain preferred embodiment of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing figures, the several views present:

FIGS. 1 and 1A are overviews of the present invention;

FIGS. 2 and 2A show the implementation of the present invention; and,

FIG. 3 is a further additional implementation of the invention.

### DESCRIPTION OF THE REFERENCED NUMERALS

Turning now descriptively to the drawings, in which similar reference characters denote similar elements throughout the several views, the figures illustrate the use of the present invention. With regard to the reference numerals used, the following numbering is used throughout the various drawing figures:
10 present invention
12 offer of charitable contribution step
14 contribution amount decision step
16 buyer purchasing step
18 financial instrument step
20 seller accepts payment step
22 transaction receipt generation step
24 donor recipient choosing step
26 buyer charity recipient choosing step
28 seller charity recipient choosing step
30 contribution tax receipt generation step
32 tax receipt forwarding step
34 donor account access using app
36 seller provides goods/services with integral charitable donor portion
38 buyer contacts seller
40 buyer initiates purchase
42 buyer selects item
44 buyer selects financial instrument
46 “master” list of qualified organizations/tax receipt generation
48 donor optional specific charity
50 “master” organization provides donor contribution database and donor app accessing donor account records.
52 “master” disburses funds to designated charity.
54 seller providing goods and/or services
56 predetermined amount of seller's price is donor charitable contribution
58 seller optionally allows donor to determine sum sent
60 “master” organization generates donor charitable contribution tax receipt
62 receipt sent to donors designated address
64 “master” forwards charitable contribution to designated charity
66 “master” provides donor account database and app accessing donor contributions

### DETAILED DESCRIPTION OF THE DRAWING FIGURES AND PREFERRED EMBODIMENTS

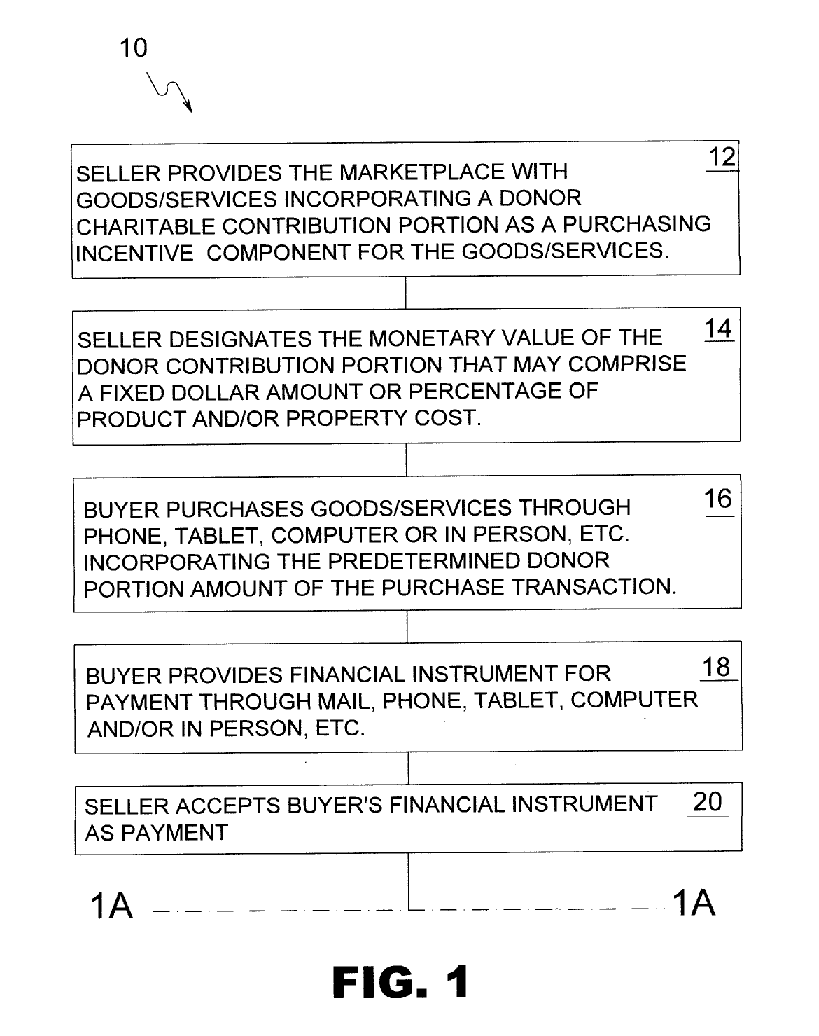

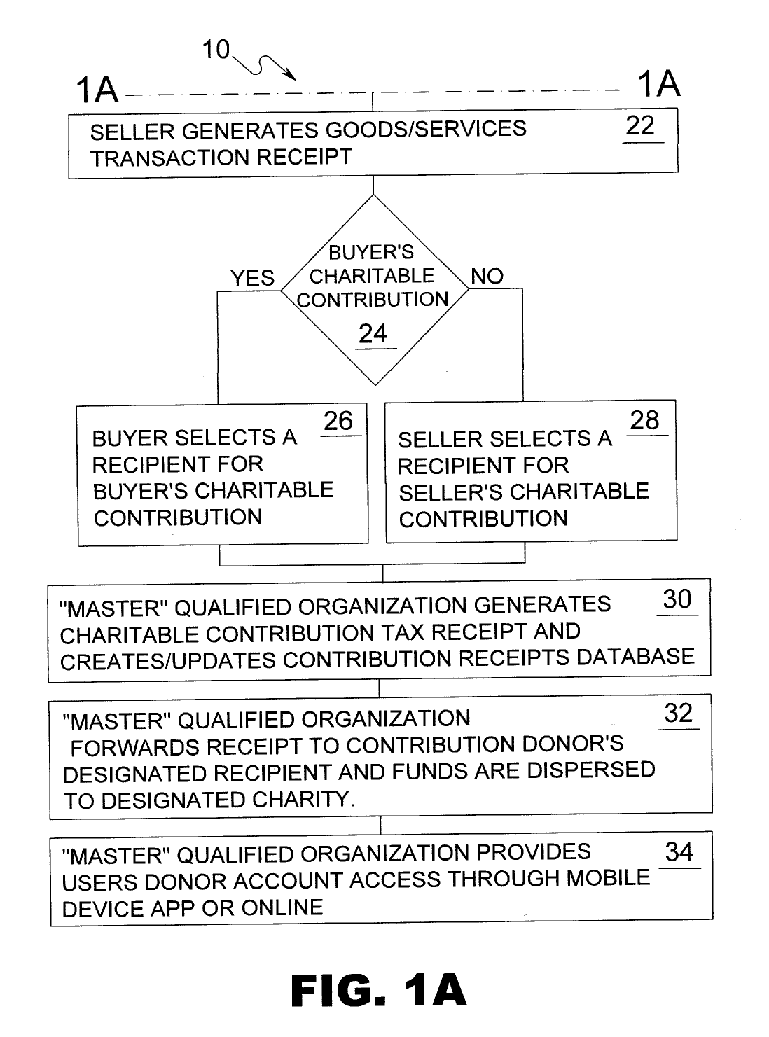

In FIGS. 1 and 1A an overview of the invention is shown and is indicated at 10. The seller of a good or service offers a charitable contribution portion as an incentive for purchase as indicated at 12. The amount of the charitable contribution may be a fixed amount per purchase or it may be a percentage of the purchase price as indicated at 14. In the buyer purchasing steps seen at 16 and 18 the buyer either online through a computer, tablet, or phone, or in person agrees to the purchase and designates the financial instrument that they desire to use (credit, debit, checking, etc). At 20 the seller will accept the payment (financial instrument) and then the master charity will generate the transaction receipt as indicated at 22 as seen in FIG. 1A. The recipient of the charitable tax receipt contribution 24 may be either the buyer and/or seller of the goods/services with either party optionally selecting .a charity from a list of qualified charities or accepting an offered default charity as indicated at 26, 28. The “Master” qualified organization generates the charitable contribution tax receipt to the donor and maintains a charitable donor account database at 30. “Master” qualified organization forwards receipt to contribution donor's designated recipient and funds are dispersed to designated charity as seen at 32. “Master” qualified organization provides computer application for account donors access as seen at 34.

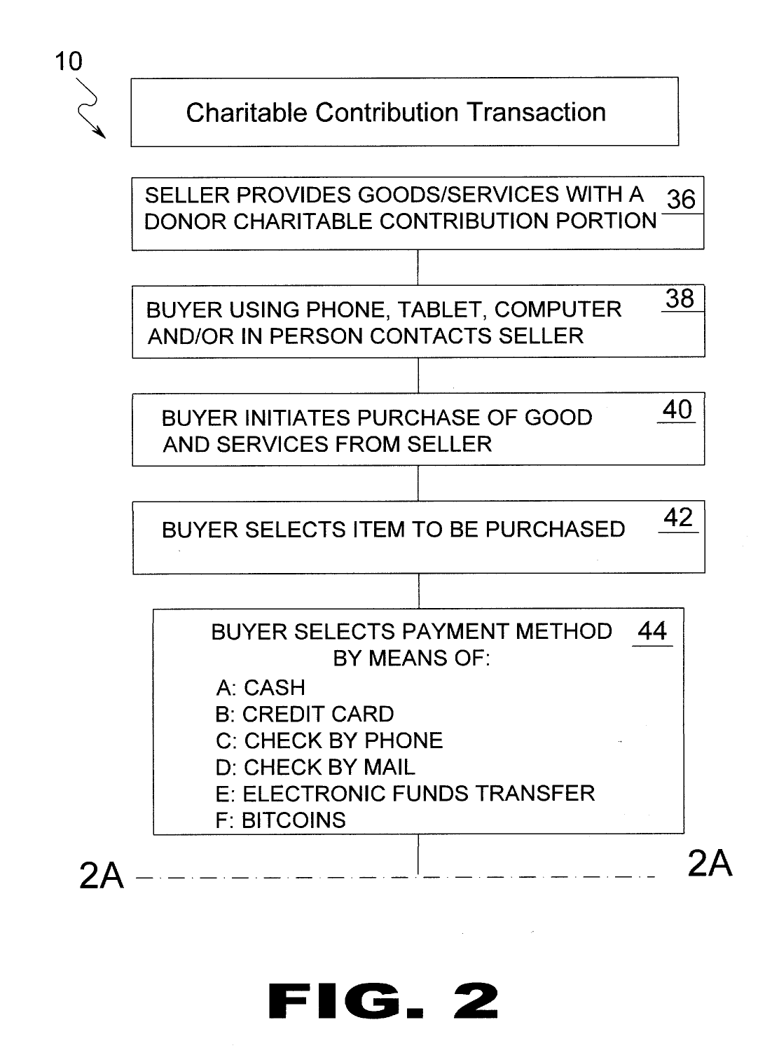

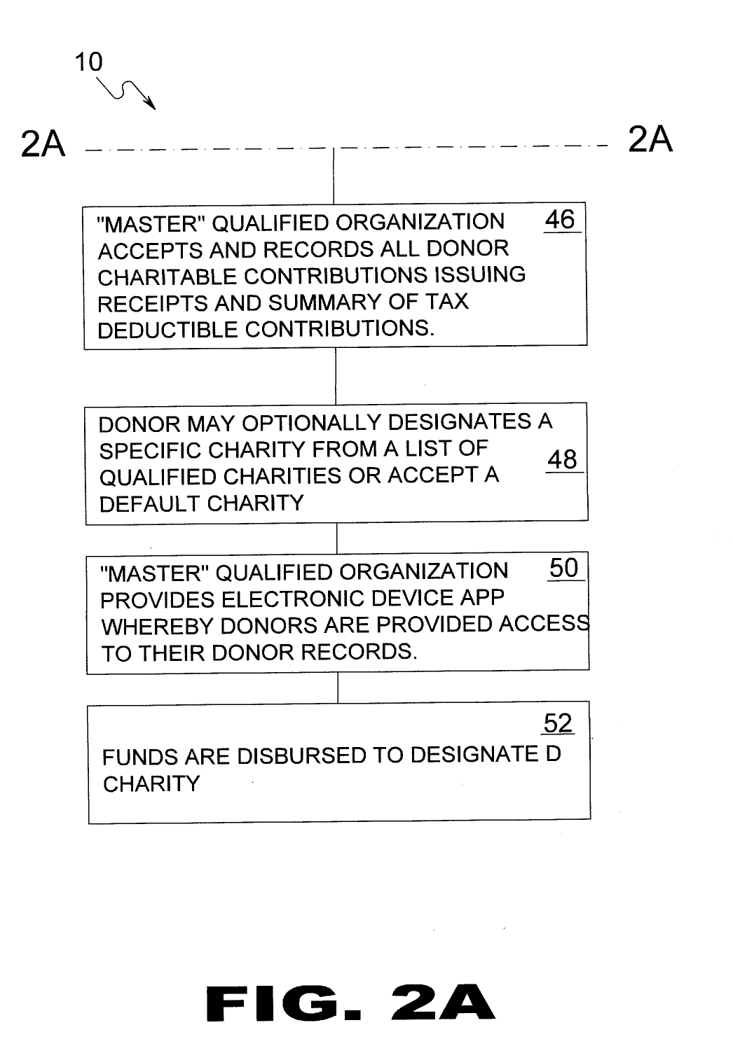

In FIGS. 2 and 2A the implementation of the present invention 10 is seen. The seller of a good or service offers a charitable contribution portion as an incentive for purchase as indicated at 36. The buyer contacts the seller at 38 through a phone, a computer, a tablet, or in person, etc. and initiates the purchase at 40. The buyer selects the item at 42, and the buyer further selects the desired financial instrument at 44. Turning to FIG. 2A at 46 a “master” qualified organization accepts and keeps track of all charitable contributions and issues receipts and summary for income tax deductions and additionally, tax contribution receipts are generated and sent to the appropriate agency or person. Optionally at 48 the donor designates a specified organization or charity or accepting a default charity. The “Master” qualified organization provides computer application for account donors access as seen at 50 and the funds assigned are disbursed at 52.

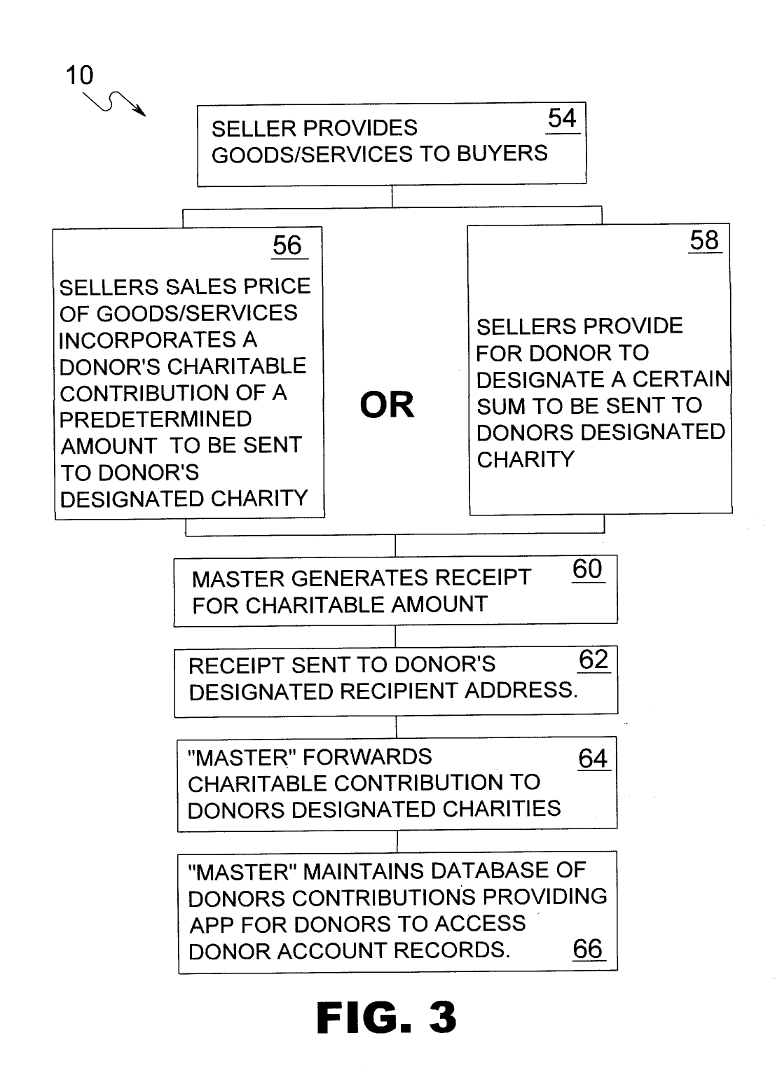

In FIG. 3 we see the implementation of the present invention 10 from the seller's side. The seller offers to provide goods and services at 54. One way of making the offer attractive to a group is to say that a predetermined amount of the seller's price will be donated to a charity as indicated at 56. As seen previously, the recipient of the charitable tax receipt contribution may be either the buyer and/or seller of the goods/services with either party optionally selecting a charity from a list of qualified charities or accepting an offered default charity. Optionally at 58, the donor can designate a certain sum for this contribution to be sent to donor's desired charity. At 60 the charitable receipt in the name of the donor is generated and sent to the donor's designated recipient address, as indicated at 62. It is contemplated that the receipt thus generated with the donor's name thereon would or could also be sent to any other designated address provided by the donor. The “master” qualified organization then disburses the amount agreed on to the donor's designated organization as seen at 64. The “Master” organization maintains an account for all contribution in a donor contribution database and a computer application for account holders to access their charitable contribution records as seen in 66.

The method of the present invention is to be practiced through a series of computerized terminals collectively forming a financial computerized network with individual terminals accessible to the person rendering the charitable contribution, the charity itself and/or the provider of a good or service.

It will be understood that each of the elements described above, or two or more together may also find a useful application in other types of methods differing from the type described above.

While only several embodiments of the present invention have been shown and described, it will be obvious to those skilled in the art that many modifications may be made to the present invention without departing from the spirit and scope thereof.

What is claimed is:

1. A method for attributing and generating charitable tax receipts comprising the steps of:
offering a good or service for sale combined with a monetary donation to a charitable organization;
determining a monetary amount of said monetary charitable donation;
determining a donor's personal information when said donor agrees to purchase said offered good or service;
generating a charitable donation tax receipt from said donor's personal information;
providing a master qualified organization for tracking donations;
sending said charitable donation tax receipt to at least one predetermined address or printer; and,
providing a series of computerized terminals forming a financial network for, at least, said donor and said master qualified organization.

2. The method for attributing and generating charitable tax receipts as claimed in claim 1. wherein said first determining step where said amount of said monetary charitable donation is a percentage of the price of said good or service.

3. The method for attributing and generating charitable tax receipts according to claim 2, wherein the donor donates to the master qualified organization and may choose a charity from a list of charitable organizations.

4. The method for attributing and generating charitable tax receipts according to claim 3, wherein said second determining step wherein said donor agrees to purchase the good or service further includes a financial instrument.

5. The method for attributing and generating charitable tax receipts according to claim 4, wherein said financial instrument is a credit card.

6. The method for attributing and generating charitable tax receipts according to claim 4, wherein said financial instrument is a debit card.

7. The method for attributing and generating charitable tax receipts according to claim 4, wherein said financial instrument is an electronic fund transfer.

8. The method for attributing and generating charitable tax receipts according to claim 4, wherein said financial instrument is a cryptocurrency.

9. The method for attributing and generating charitable tax receipts according to claim 4, wherein said financial instrument is cash.

10. The method for attributing and generating charitable tax receipts as claimed in claim 1, wherein said first determining step where said amount of said monetary charitable donation is a certain amount of each said good or service purchased.

11. The method for attributing and generating charitable tax receipts according to claim 10, wherein said donor chooses said charitable organization that receives said charitable monetary donation from a list.

12. The method for attributing and generating charitable tax receipts according to claim 11, wherein said second determining step wherein said donor agrees to purchase the good or service further includes a financial instrument.

13. The method for attributing and generating charitable tax receipts according to claim 12, wherein said financial instrument is a credit card.

14. The method for attributing and generating charitable tax receipts according to claim 12, wherein said financial instrument is a debit card.

15. The method for attributing and generating charitable tax receipts according to claim 12, wherein said financial instrument is an electronic fund transfer.

16. The method for attributing and generating charitable tax receipts according to claim 12, wherein said financial instrument is a cryptocurrency.

17. The method for attributing and generating charitable tax receipts according to claim 12 wherein said financial instrument is cash.
